(19) United States
(12) Patent Application Publication
(10) Pub. No.: US 2007/0237873 A1
(43) Pub. Date: Oct. 11, 2007

(54) Jelly candy having electrolytes

(76) Inventor: Herman G. Rowland, Suisun City, CA (US)

Correspondence Address: JAMES R. CYPHER, 405 14TH STREET, SUITE 1607, OAKLAND, CA, 94612, US

(21) Appl. No.: 11/399,929

(22) Filed: Apr. 7, 2006

(51) Int. Cl. A23L 1/05

(52) U.S. Cl. 426/573

(57) ABSTRACT

A jelly candy has an edible center, the center contains a controlled amount of potassium, the center is also characterized by a relatively rigid, resilient texture, its ability to set rapidly during manufacture, its brilliant appearance, and its lack of tailings both during manufacture and during consumption.

### BACKGROUND OF THE INVENTION

This invention relates to an improved jelly candy containing the electrolyte potassium and to the method of making the same.

Jelly candies are typically made from a sweetening agent, a congealing agent, a flavoring agent and water. The congealing agent provides texture and body to the candy as well as water retention properties.

Jelly candies are a class of confectionary which is generally characterized by a short, relatively rigid, resilient texture as compared to the tactile, long, cream-like texture of masrshmallows, caramels and the like.

Jelly candies also preferably have no tailings during manufacture and no tailings during consumption. Tailings are the strings which occur when the candy is separated into pieces, as by biting. Tailing during manufacture occurs between the dispenser and the shots of candy in the mold. Tailing during consumption occurs when one bites into the candy and the candy does not break or fracture cleanly. In comparison caramel and toffee candies are supposed to have tailings.

Jelly candies also preferably are heat resistant which is to say they will not melt at ambient temperatures, nor will they lose their shape or resilience or sweat. Jelly candies also preferably have centers with a brilliant appearance.

Jelly candies also preferably have centers with relatively short setting times, thus the time between the setting of the edible centers in their molds and their being panned to create their edible coating is reduced.

There is a need to produce a jelly candy having electrolytes, specifically the electrolytes sodium and potassium, while still having the pleasant characteristics associated with jelly candies. The present invention addressed that need.

### SUMMARY OF THE INVENTION

It is an object of the present invention to provide a jelly candy having an edible center, the center containing a controlled amount of potassium, the center also being characterized by a relatively rigid, resilient texture, its ability to set rapidly during manufacture, its brilliant appearance, and its lack of tailings both during manufacture and during consumption.

If it is a further object of the present invention to provide the edible center of the present invention with an edible outer shell or coating to create a jelly candy, commonly known as a jelly bean.

It is an object of the present invention to provide a method of making a jelly candy having potassium, wherein a syrup is cooked having a congealing agent, a sweetening agent, a flavoring agent and potassium. The cooked syrup is then deposited in small measured portions into depression in a bed of dry powdered molding starch. The surface of the bed of molding starch is first smoothed over, and then imprinted with depression of the desired shape. The freshly deposited jelly candy center is relatively soft and semi-fluid. It is then allowed to age to achieve the desired gel structure. During the aging or conditioning process, the syrup sets up to form a resilient and firm gel, the syrup loses water, and the surface of the jelly candy center develops a desired structure, which is glossy and smooth and should be firm enough for subsequent panning operations. After conditioning, the jelly candy confections screened from the molding starch and then prepared for panning and then panned.

### BRIEF DESCRIPTION OF THE DRAWINGS

FIG. 1 is a top view of an edible center of a jelly candy made according to the present invention.

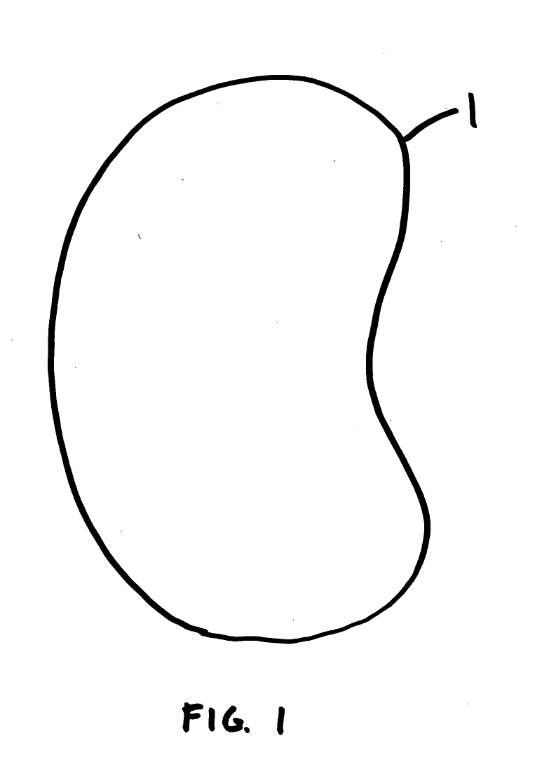

FIG. 2 is a parital cross-sectional top view of an edible center of a jelly candy formed with an outer coating according to the present invention.

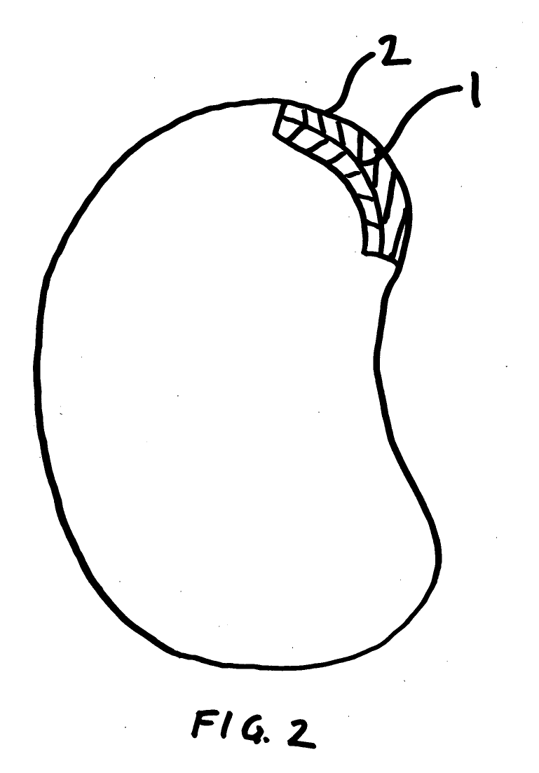

### DETAILED DESCRIPTION OF THE INVENTION

A jelly candy formed according to the present invention has a center 1 formed by mixing water, a sweetening agent or agents, a congealing agent, a flavoring agent, a coloring agent, and potassium in the form of potassium citrate.

In the preferred embodiment of the present invention, the edible center is coated with an edible outer shell 2.

The preferred embodiment of the present invention is made according to the present invention. The doses of all vitamins and masking flavor are carefully weighed, and pre-blended with Baker's Special sugar or powdered sugar. In the preferred embodiment the vitamins consist of Vitamin E Acetate, Ascorbic acid, Thiamine, Riboflavin, and Nianciamide. Each sub-batch kettle's worth of this vitamin premixture is placed in a zippered bag to protect ingredients until needed for production.

A sub mixture or pre-mixture of congealing agents is also made. The primary congealing agent can be starch or pectin. The preferred primary congealing agent is pectin. The preferred pectin-based premixture consists of water, sodium citrate, citric acid, and pectin. A citric acid solution is also separately made and stored for later addition.

The doses of salt and potassium citrate are also separated weighed and measured, and these ingredients are separately blended with fine granular sugar or powdered sugar in a bucket for each sub-batch kettle that will be produced that day. The vitamin premixture is then blended with these other ingredients, making sure that all ingredients are thoroughly dispersed in the bucket.

A master batch of the base center formulation is then made. The base center formulation includes water, corn syrup, sugar, and a portion of the pectin-based premix. After weighing, the batch of base center formulation, which now takes the form of slurry, is discharged into a tempering vessel, where the base center formulation slurry is preheated under constant agitation.

After a second batch of base center formulation slurry has been created, weighed, discharged, and preheated, the kitchen supervisor begins to cook this base formula. The product is pumped past a filter, through a coil cooker, and into a flash-off holding vessel where the cooked base center formulation awaits the next step.

The next step is done in a sub-batch kettle. About ½-¾ of the cooked base center formulation slurry needed for the batch is introduced. Color, flavor, and sodium lactate are then added, and then the remainder of the base center formulation slurry.

To preserve the potency of the vitamins, which are generally heat sensitive, the vitamins, masking flavor, salt and potassium citrate premixture and the citric acid solution are not added to the base center formulation slurry until just before the slurry is ready to be inserted into the mogul or starch molding machine, where the base center formulation slurry will be deposited into starch moulds. When the vitamins, masking flavor, salt and potassium citrate premixture is added to the base center formulation slurry an enriched base center formulation slurry is created.

The enriched slurry is kept warm in a jacketed hopper which keeps the material from setting up before it can be injected into the moulds. This hopper feeds a positive displacement pump, with nozzles that line up with a tray of molding starch that has the impression of jelly bean-shaped centers 1 pressed into the surface.

The amount of enriched base center formulationslurry that is deposited in each tray of starch moulds is weighed carefully so that the amount of potassium and sodium in each edible center is uniform.

The trays of centers 1 are then taken to a curing room where for the next 36 hours, heated, conditioned air is blown across the trays of centers. This removes excess moisture from the product, and allows the pectin to set up and give the mass the structure necessary to hold its bean shape for the rest of the process. At the end of the heating cycle, 12 hours of cooling bring the temperature of the product back down to ambient conditions for further processing.

The trays of centers 1 are demolded, separating the edible centers from the starch in which they were molded. The edible centers 1 are brushed and further cleaned with air to make sure that all molding starch is removed prior to the next step.

The edible centers 1 are conveyed through a blast of low pressure steam to wet the surface of the pieces and directly into a sugar sander (rotating tumbler filled with fine granular sugar), where fine granular sugar adheres to the wetted surface of the edible centers 1. This acts as a separating agent to keep the pieces from sticking together while they dry in vented trays for the next 24 hours. In the preferred embodiment, where the edible center 1 is provided with an edible outer shell 2, the granular sugar adhering to the edible centers 1 also acts as a foundation to build the sugar outer shell 2 that gives the jelly candy the outer surface appearance and texture of a jelly bean.

In the preferred embodiment, the sanded centers 1 are then dumped into smooth, rotating pans for the next step of the process. Measured amounts of engrossing syrup (a mixture of water, sugar and corn syrup), along with additional color and flavor are added to the sanded centers 1 as they tumble in the rotating pans. As soon as the centers 1 are covered with this engrossing syrup mixture, fine granular sugar is added to pans to begin working with the syrup-coated centers 1 to build the sugar shell 2 up.

Three more layers of syrup and sugar are added, until the right amount of shell 2 has been created, making each bean weigh 2 grams with the center 1 to shell 2 ration being 68.5% to 31.5%. After the last “wetting” of syrup, finer grades of sugar are used to begin smoothing out the surface of the shell. Powder sugar is the final ingredient added, making the surface nice and smooth.

The engrossed centers are removed from the smooth revolving pans and returned to vented trays, where they stored in a conditioned room for 24 hours. During this time, they dry out and firm up, preparing them for the next step, polishing.

The edible centers 1 having an outer shell 2 are then dumped into rotating pans with ridges rolled into the perimeter. The polishing process begins with a concentrated sugar-water solution with a small amount of extra color being added a few ounces at a time, until all of the powdered sugar from the engrossing process dissolves, and the final color that represents this batch of jelly beans shines through, and the surface becomes very smooth.

The second step of polishing the beans has the operator adding a measured dose of food grade wax. As the beans tumble on themselves, they buff the waxes that have been added, making the surface very shiny. Because the surface is smooth, and is becoming waxy slick, the ridges that are rolled into these pans continue to keep the beans tumbling instead of sliding.

The final step of polishing is when a food-grade confectionery glaze is added to the surface to seal in the shine. Cool, dry, conditioned air is introduced into the pans to help the glaze set up. Once dry, the glaze will seal in the shine and give the beans a protective coating to improve their shelf life. The polished beans are removed from the pans, and placed into vented trays, where they are stored in a conditioned room for 24-48 hours, allowing the surface coating to completely set before packing.

To prepare the beans for packaging, the trays are dumped into a sorting drum, which will separate the pieces that are too large or small to be near the 2 gram size. The ideal size pieces are then conveyed to a packaging machine, which will weigh the right amount of product into bags formed from a roll of flat film. These bags of jelly beans are then packed into the final carton that will be sold to the customers.

Using 2 gram jelly beans as the desired size, 1 ounce of jelly bean candies made according to the preferred method of the present invention will have 80 mg of Sodium, 40 mg of Potassium and 10% of the recommended daily values of Ascorbic Acid, Thiamin, Riboflavin and Niancin. Other levels and ratios of these ingredients are also possible, but the ratios and levels listed above are preferred.

Table 1 provides a listing of the ingredients by percentage in the preferred finished product according to the present invention.

TABLE 1

| Ingredient | Percent in Finished Product |
|---|---|
| Water | preferably 2.63% |
| Pectin | preferably 1.25% |
| Sugar | preferably 59.1% |
| Corn Syrup | preferably 32.8% |
| Citric Acid | 1 to 3%, preferably 1.9% |
| Sodium Citrate | 0.1 to 0.3%, preferably .25% |
| Flavorings | preferably 0.1 to .3% |
| Dye | preferably 0.05 to 0.16% |
| Salt | preferably 0.48% |
| Sodium Lactate | preferably 0.48% |
| Ascorbic Acid | preferably 0.04% |
| Wax | preferably 0.26% |
| Potassium Citrate | preferably 0.4505% |
| Thiamine Hydrochloride | |
| (B1) | preferably 0.0009% |
| Riboflavin (B2) | preferably 0.0008 |
| Niacinamide (B3) | preferably 0.009% |

We claim:

1. A jelly candy comprising:
an edible center that is resilient and firm enough for tumbling in a revolving pan, the edible center comprising, a sweetening agent, a congealing agent and potassium.

2. The jelly candy of claim 1, comprising:
an edible outer coating shell surrounding the edible center, the outer coating shell being primarily made of sugar.

3. The jelly candy of claim 1, comprising:
a flavoring agent added to the edible center.

4. A method of making a jelly candy, comprising the steps of:
a. creating a syrup that has a congealing agent, a sweetening agent, a flavoring agent and potassium;
b. depositing the syrup in small measured portions to create edible centers; and
c. aging the edible centers to the desired gel structure.

5. The method of claim 4, further comprising the steps of coating the edible centers with sugar.

6. The method of claim 5, further comprising:
panning the edible centers to create an edible outer shell.

7. The method of claim 6, futher comprising
depositing the measured potions of syrup into depressions in a bed of dry powdered molding starch.

8. A jelly candy comprising:
an edible center that is resilient and firm enough for tumbling in a revolving pan, the edible center consisting essentially of, a sweetening agent, a congealing agent and potassium.

9. The jelly candy of claim 8, comprising:
an edible outer coating shell surrounding the edible center, the outer coating shell being primarily made of sugar.

10. The jelly candy of claim 8, comprising:
a flavoring agent added to the edible center.
